(19) United States
(12) Patent Application Publication
(10) Pub. No.: US 2003/0048235 A1
(43) Pub. Date: Mar. 13, 2003

(54) Monopole antenna having a wave-shaped metal plate

(75) Inventors: Isao Fukae, Tokyo (JP); Masaaki Miyata, Tokyo (JP); Akira Miyoshi, Tokyo (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Mitsumi Electric Co. Ltd., Tokyo (JP)

(21) Appl. No.: 10/235,528

(22) Filed: Sep. 5, 2002

(30) Foreign Application Priority Data
Sep. 7, 2001 (JP) 272185/2001

(51) Int. Cl. H01Q 1/36

(52) U.S. Cl. 343/895

(57) ABSTRACT

In a monopole antenna having a monopole standing up on one surface of a circuit board, a metal case is provided on the other surface of the circuit board. The monopole and the metal case are covered with an exterior case. The metal case includes a base plate portion faced to the circuit board with a space kept therefrom, a side surface portion extending from a circumferential or peripheral edge of the base plate portion toward the circuit board and fixed to the circuit board, and a belt-like metal plate disposed outside the side surface portion and extending in the circumferential direction. The belt-like metal plate has a part which forms a wave-like shape of a wave traveling in the circumferential direction and is press-fitted between the side surface portion and the exterior case.

### BACKGROUND OF THE INVENTION

This invention relates to a digital radio receiver for receiving a radio wave from an artificial satellite (which may be called a “satellite wave” hereinafter) or a radio wave from a ground station (which may be called a “ground wave” hereinafter) to listen to digital radio broadcasting and, in particular, to a monopole antenna for use in the digital radio receiver.

In recent years, a digital radio receiver for receiving a radio wave from an artificial satellite (satellite wave) or a ground wave to listen to digital radio broadcasting has been developed and is about to be put into practical use in United States of America. The digital radio receiver is mounted on a mobile station such as a vehicle and is adapted to receive a radio wave having a frequency of about 2.3 GHz to listen to the digital radio broadcasting. In other words, the digital radio receiver is a radio receiver capable of listening to mobile broadcasting. It is noted here that the ground wave is a radio wave obtained by slightly shifting the frequency of the satellite wave after it is received by the ground station.

In order to receive the radio wave having the frequency of about 2.3 GHz, it is necessary to mount an antenna at a position outside a vehicle. Such antenna may have various structures, but a stick type is generally used rather than a planar type (or a flat type). As well known, an electromagnetic wave emitted into a free space is a transversal wave having an electric field and a magnetic field vibrating in a plane perpendicular to a propagating direction of the wave. The electric field and the magnetic field are variable in intensity within the above-mentioned plane. Such electromagnetic wave is referred to as a polarized wave. The satellite wave is a circular polarized wave exhibiting circular polarization while the ground wave is a linear polarized wave exhibiting linear polarization.

Hereinafter, description will be made mainly about an antenna for receiving the ground wave. As one of stick-type antennas, a monopole antenna with a finite ground plane is known. The monopole antenna comprises a circuit board called a finite ground plane and a monopole standing up on one surface thereof. The circuit board has a lower surface with a LNA (low noise amplifier) mounted thereon and the other surface covered with a metal case to thereby change radiation characteristics in a direction of an elevation angle.

In order to fix the monopole antenna to an exterior or outer case, the circuit board is provided with threaded holes for thread engagement. However, in order to allow the work of engaging the antenna with the exterior case, it is inevitable to form a space in the metal case. The presence of the space might unfavorably result in uneven distribution or inclination in the radiation characteristics.

As a covering member for covering or shielding the space, it is proposed to use a metal tape. In case where the metal tape is attached by the use of an adhesive, attachment is easy. However, the metal tape might be detached because of malfunction of the adhesive when used in a high-temperature environment.

### SUMMARY OF THE INVENTION

It is therefore an object of this invention to provide a monopole antenna which is capable of preventing detachment of the above-mentioned covering member and still maintaining attachability thereof.

Other objects of the present invention will become clear as the description proceeds.

According to an aspect of the present invention, there is provided a monopole antenna comprising a circuit board having a first and a second surface which are opposite to each other, a monopole fixed to the circuit board and projecting from the first surface, a metal case disposed on the second surface, and an exterior case covering the monopole and the metal case. The metal case comprises a base plate portion faced to the circuit board with an axial space left therebetween, a side surface portion extending from a periphery of the base plate portion toward the circuit board and fixed to the circuit board, and a belt-like metal plate disposed outside the side surface portion and extending in a circumferential direction of the monopole. The belt-like metal plate has a part which forms a wave-like shape of a wave traveling in the circumferential direction and is press-fitted between the side surface portion and the exterior case.

### BRIEF DESCRIPTION OF THE DRAWINGS

FIG. 1A is a plan view of a monopole antenna according to one embodiment of the present invention with an exterior case depicted by an imaginary line;

FIG. 1B is a front view of the monopole antenna illustrated in FIG. 1A;

FIG. 2 is a developed view of a metal case in the monopole antenna in FIG. 1;

FIG. 3 is a perspective view of a part of a belt-like metal plate in the monopole antenna in FIG. 1.

### DESCRIPTION OF THE PREFERRED EMBODIMENTS

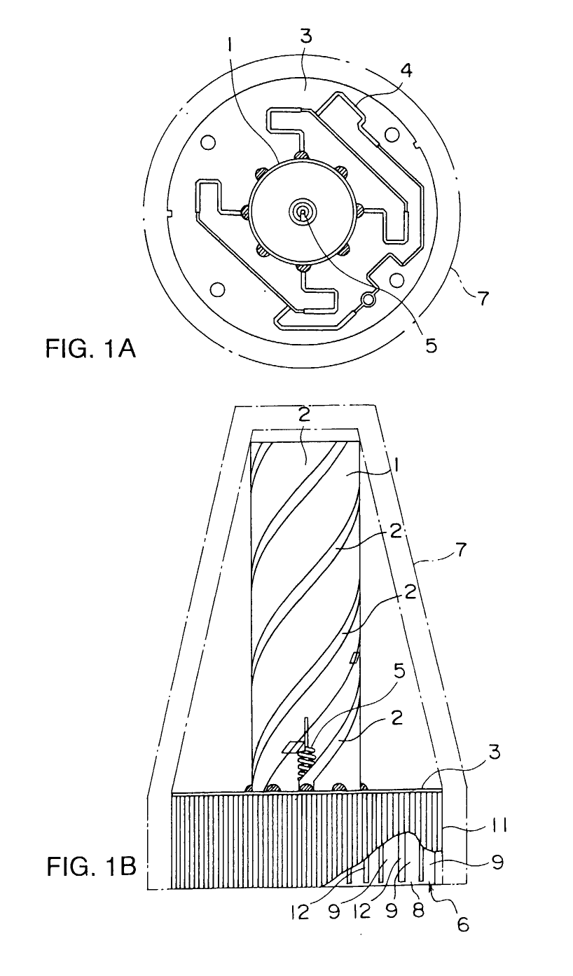

With reference to FIGS. 1A and 1B, description will be made about a monopole antenna according to one embodiment of the present invention.

The monopole antenna shown in the figures is a composite antenna comprising a typical monopole antenna and a helical antenna added thereto. The monopole antenna comprises a cylindrical body 1 formed by a flexible insulating film member rolled into a cylindrical shape and fixed to keep the cylindrical shape, four antenna patterns 2 each of which comprises a conductor and is formed on the cylindrical body 1 to extend in a helical fashion or shape along its peripheral surface, a circuit board 3 fixed to one of axial ends of the cylindrical body 1, a circuit pattern 4, such as a phase-shift circuit, formed on the circuit board 3 and connected to the antenna patterns 2 by soldering, and a monopole 5 fixed to the circuit board 3 and projecting from one surface of the circuit board 3 into the interior of the cylindrical body 1. The antenna patterns 2 serve as a so-called helical antenna. The monopole 5 serves as a so-called pole antenna. The circuit board 3 serves as a so-called finite ground plane.

On the other surface of the circuit board 3, a metal case 6 (which will be later described) is provided. The cylindrical body 1, the circuit board 3, and the metal case 6 are covered with an insulating exterior case 7. Thus, the monopole 5 is also covered with the exterior case 7. In order to clearly show the internal structure, the exterior case 7 is depicted by a dot-and-dash line in the figures.

The metal case 6 comprises a base plate portion 8 faced to the circuit board 3 with an axial space left therebetween, a plurality of foot portions 9 folded up from a circumferential or peripheral edge of the base plate portion 8 towards the circuit board 3 and fixed to the circuit board 3, for example, by soldering, and a belt-like metal plate 11 disposed outside the foot portions 9 and extending in a circumferential direction of the monopole 5. The foot portions 9 are arranged in the circumferential direction with circumferential spaces 12 having various sizes left between every adjacent ones. Through these circumferential spaces 12, an output cable can be led out, or the work of engaging the monopole antenna to the exterior case 7 can be performed.

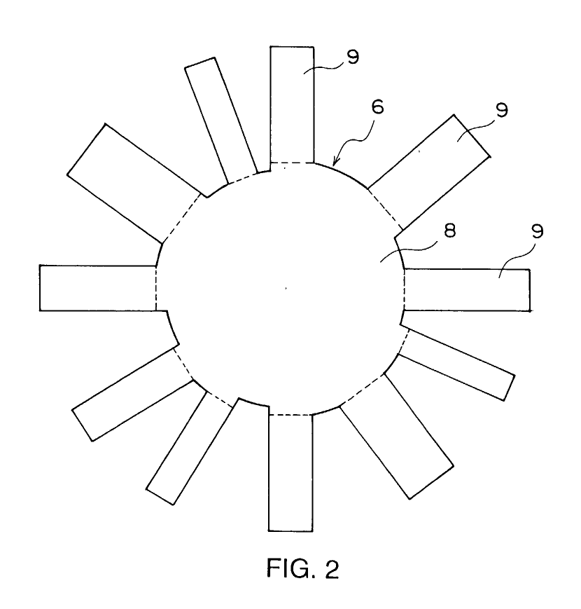

As exemplified in FIG. 2 as a developed view, the base plate portion 8 and the foot portions 9 are formed by a single flat metal plate having a shape such that a plurality of the foot portions 9 are extended outward from the circumferential edge of the base plate portion 8. The foot portions 9 are perpendicularly folded on the side of one surface of the base plate portion 8 so that a side surface portion is formed by the foot portions 9. Folding positions are shown by broken lines.

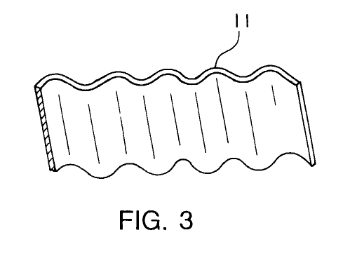

As shown in FIG. 3, the belt-like metal plate 11 is made of a corrugated plate. More particularly, the belt-like metal plate 11 comprises at least one part which forms a wave-like shape of a wave traveling in the circumferential direction. The wave shape of the belt-like metal plate 11 has a cycle of about several millimeters and an amplitude corresponding to about one half of the cycle. The belt-like metal plate 11 is press-fitted between the side surface portion, that is, the foot portions 9 and the exterior case 7 and fixed and held under a frictional force based on an elastic restoring force of the belt-like metal plate 11. With this structure, the belt-like metal plate 11 can be easily attached. Furthermore, because of absence of an unstable factor such as the use of an adhesive, the attached state can be reliably maintained.

In order to clearly show the internal structure, a part is cut out in FIG. 1B. However, it is desirable that the belt-like metal plate 11 has a width substantially equal to the length of the foot portions 9, i.e., the width of the side surface portion and that the belt-like metal plate 11 covers all of the spaces 12 except for the one through which an output cable is led out. The belt-like metal plate 11 may be divided into a plurality of sections in the circumferential direction.

Moreover, it is desirable that the cycle and the amplitude of the wave shape of the belt-like metal plate 11 are selected so that a greater number of contact points are formed between the belt-like metal plate 11 and that the belt-like metal plate 11 is reliably fixed and held between the exterior case 7 and the metal case 6.

What is claimed is:

1. A monopole antenna comprising:
a circuit board having a first and a second surface which are opposite to each other;
a monopole fixed to said circuit board and projecting from said first surface;
a metal case disposed on said second surface; and
an exterior case covering said monopole and said metal case,
said metal case comprising:
a base plate portion faced to said circuit board with an axial space left therebetween;
a side surface portion extending from a periphery of said base plate portion toward said circuit board and fixed to said circuit board; and
a belt-like metal plate disposed outside said side surface portion and extending in a circumferential direction of said monopole, said belt-like metal plate having a part which forms a wave-like shape of a wave traveling in said circumferential direction and is press-fitted between said side surface portion and said exterior case.

2. The monopole antenna according to claim 1, wherein said belt-like metal plate is made of a corrugated plate.

3. The monopole antenna according to claim 1, wherein said wavelike shape has a cycle of about several millimeters.

4. The monopole antenna according to claim 1, wherein said wavelike shape has an amplitude corresponding to about one half of said cycle.

5. The monopole antenna according to claim 1, wherein said side surface portion is defined by a plurality of foot portions arranged in the circumferential direction and by a plurality of circumferential spaces left therebetween.

6. The monopole antenna according to claim 4, wherein at least one of said circumferential spaces is not covered with said belt-like metal plate.

7. The monopole antenna according to claim 1, wherein said belt-like metal plate has a width substantially equivalent to that of said side surface portion.

8. The monopole antenna according to claim 1, wherein said belt-like metal plate is divided into a plurality of sections in the circumferential direction.

9. The monopole antenna according to claim 1, wherein said circuit board is a finite ground plane.

10. The monopole antenna according to claim 1, further comprising:
a cylindrical body fixed on said circuit board and projecting from said first surface; and
an antenna pattern extending along said cylindrical body; said monopole being disposed inside said cylindrical body, said exterior case further covering said cylindrical body.

11. The monopole antenna according to claim 10, wherein said cylindrical body comprises an insulating film member rolled into a cylindrical shape.

12. The monopole antenna according to claim 10, further comprising a circuit pattern which is formed on said circuit board and connected to said antenna pattern.

13. The monopole antenna according to claim 10, wherein said circuit board is a phase shifter substrate having a phase shifting circuit.

14. The monopole antenna according to claim 10, wherein said antenna pattern extends in a helical shape.
